(19) United States
(12) Patent Application Publication
(10) Pub. No.: US 2014/0295870 A1
(43) Pub. Date: Oct. 2, 2014

(54) Remotely Managed Data Radios Including Remote Management Capabilities

(71) Applicant: CALAMP CORP., Oxnard, CA (US)

(72) Inventors: Lloyd Wendland, Newport Beach, CA (US); Somu Ramiah, Eden Prairie, MN (US)

(73) Assignee: CALAMP CORP.

(21) Appl. No.: 14/307,064

(22) Filed: Jun. 17, 2014

Related U.S. Application Data
(63) Continuation of application No. 13/396,249, filed on Feb. 14, 2012.

(51) Int. Cl. H04W 28/20; H04W 72/10

(52) U.S. Cl. CPC H04W 28/20; H04W 72/10; H04W 88/06
USPC 455/452.1

(57) ABSTRACT

Systems and methods for remotely managed data radios in accordance with embodiments of the invention are illustrated. In one embodiment of the invention, a remotely managed data radio includes first and second data radio modules, wherein the first data radio module configured to communicate on a first network including an amount of bandwidth and a latency for a given frequency channel, wherein the second data radio module is configured to communicate on a second network, and wherein the remotely managed data radio is configured to communicate mission-critical data utilizing the first data radio module, measure the performance of the first network using the first data radio module, generate non-mission-critical data using the second data radio module, where the non-mission-critical data includes the measured performance data, and communicate the non-mission-critical data utilizing the second data radio module, thereby preserving the bandwidth and latency of the primary network for communicating mission-critical data.

### CROSS-REFERENCE TO RELATED APPLICATIONS

The current application is a continuation of U.S. patent application Ser. No. 13/396,249, filed Feb. 14, 2012, the disclosure of which is hereby incorporated by reference in its entirety.

### FIELD OF THE INVENTION

The present invention relates, in general, to systems and methods for remotely managed data radios; specifically systems and methods utilizing remotely managed data radios which preserve bandwidth availability for mission-critical data by transmitting non-mission-critical data on a separate network.

### BACKGROUND OF THE INVENTION

Radio, the transmission of modulated electromagnetic waves, has been used as a method of communication since the late 19th century. Several different techniques are utilized to modulate radio signals including (but not limited to) modulation techniques that utilize variations in the amplitude, frequency, and/or phase of a radio frequency or RF signal to communicate analog or digital data.

Radio is ideal for use as a communication method to provide remote control and communication with persons and machinery in the field. For example, radio communication may be utilized to implement a positive train control system. A positive train control system allows for location monitoring and speed tracking of trains and allows an operator to take control of a train in the event that the train engineer experiences difficulties. In 2008, a freight train collided with a commuter train in the Chatsworth district of Los Angeles, Calif. due to a distracted train engineer on the commuter train running a red light and colliding into the freight train, which had been given the right of way by the train dispatcher. A positive train control device is designed to enable a train dispatcher to remotely intervene and prevent collisions.

In many regions, cellular data networks have been established that enable data to be transmitted and received using mobile devices equipped with an appropriately configured data radio. Several standards exist for cellular data, including General Packet Radio Service (GPRS), Enhanced Data rates for GSM Evolution (EDGE), Evolved High-speed Packet Access (HSPA+), Evolution-Data Optimized (EVDO), Worldwide Interoperability for Microwave Access (WiMAX), and 3GPP Long Term Evolution (LTE).

### SUMMARY OF THE INVENTION

Systems and methods for remotely managed data radios in accordance with embodiments of the invention are disclosed. In one embodiment of the invention, a remotely managed data radio includes first and second data radio modules, wherein the first data radio module configured to communicate on a first network, wherein the second data radio module configured to communicate on a second network, wherein the remotely managed data radio is configured to communicate mission-critical data utilizing the first data radio module, and wherein the remotely managed data radio is configured to communicate non-mission-critical data utilizing the second data radio module.

In another embodiment of the invention, each data radio module includes an antenna module, an analog front end module, a processor, storage, and a communication module.

In an additional embodiment of the invention, the first and second data radio modules are implemented using a data radio module is configured to communicate on multiple networks.

In yet another embodiment of the invention, the second data radio module is configured to communicate with the first data radio module utilizing the communication module.

In still yet another embodiment of the invention, the second radio module is configured to manage the first data radio module.

Yet another embodiment of the invention includes a network of remote performance systems including a plurality of networks, including a first network and a second network, a data center configured to communicate data on both the first network and the second network, and a remotely managed data radio including a plurality of data radio modules, wherein the remotely managed data radio is configured to communicate on the first network and the second network, wherein the data center and the remotely managed data radio are configured to communicate mission critical data utilizing the first network, and wherein the data center and the remotely managed data radio are configured to communicate non-mission critical data utilizing the second network.

In still another additional embodiment of the invention, a data radio module includes an antenna module, an analog front end module, a processor, storage, and a communication module.

In yet still another additional embodiment of the invention, the first network is a positive train control network.

In yet another additional embodiment of the invention, the second network is a public cellular network.

Yet another embodiment of the invention includes operating a remotely managed data radio, including communicating mission critical data on a primary network using a remotely managed data radio, communicating non-mission critical data on a secondary network independent of the primary network, thereby maximizing performance of the primary network for mission critical data using the remotely managed data radio, and measuring performance of the primary network using the remotely managed data radio.

In still another embodiment of the invention, operating a remotely managed data radio includes receiving an update utilizing a secondary radio module on the remotely managed data radio via the secondary network, receiving an instruction via the secondary network using the secondary radio module to apply the update, applying the update to a primary data radio module on the remotely managed data radio, and reporting the result of the update to the primary radio module using the secondary radio module via the secondary network.

In still yet another embodiment of the invention, operating a remotely managed data radio includes determining if the secondary network is available using the secondary radio module, buffering the result of the update if the secondary network is unavailable, and reporting the result of the update when the secondary network is available using the secondary radio module.

In still another additional embodiment of the invention, the result of the update comprises the measured performance of the first network.

### BRIEF DESCRIPTION OF THE DRAWINGS

FIG. 1 is a diagram of a system for remotely managed data radios in accordance with an embodiment of the invention.

FIG. 2 is a diagram of a data radio module in accordance with an embodiment of the invention.

FIG. 3 is a flow chart illustrating a process for operating a remotely managed data radio in accordance with an embodiment of the invention.

FIG. 4 is a flow chart illustrating a process for reporting remotely managed data radio performance information in accordance with an embodiment of the invention.

FIG. 5 is a flow chart illustrating updating a remotely managed data radio in accordance with an embodiment of the invention.

### DETAILED DESCRIPTION

Turning now to the drawings, systems and methods for remotely managed data radios in accordance with embodiments of the invention are illustrated. In many embodiments, remote performance monitoring systems are deployed to monitor conditions in the field. The monitored conditions may include the conditions the radio is deployed to monitor. The monitored conditions may additionally include the performance of the remotely managed data radio and network, such as network conditions, total bandwidth, latency, firmware versions, and other factors. In order to enable communication with remote performance monitoring systems deployed in the field in a way that does not disrupt mission critical data, the remote performance systems can include multiple radio modules configured to communicate on independent radio networks. In many embodiments, a first network is used for mission critical data and a second network is used for monitoring the performance of the remote performance monitoring system.

Radio networks have a limited bandwidth for a given frequency channel. In many embodiments of the invention, remote performance monitoring systems transmit mission-critical data demanding high availability of bandwidth and/or low latency over a primary radio network. In many embodiments of the invention, the primary radio network is a positive train control network. Remote performance monitoring systems also transmit and receive non-mission-critical data. This non-mission-critical data may interfere with the available bandwidth and/or latency of mission-critical communications on the primary radio network. In order to preserve bandwidth and reduce latency on the primary radio network for mission critical data, in several embodiments of the invention, the non-mission-critical data is transmitted over a secondary radio network. In a number of embodiments, the secondary radio network is a public cellular network. Remote performance systems in accordance with embodiments of the invention are discussed further below.

### System Overview

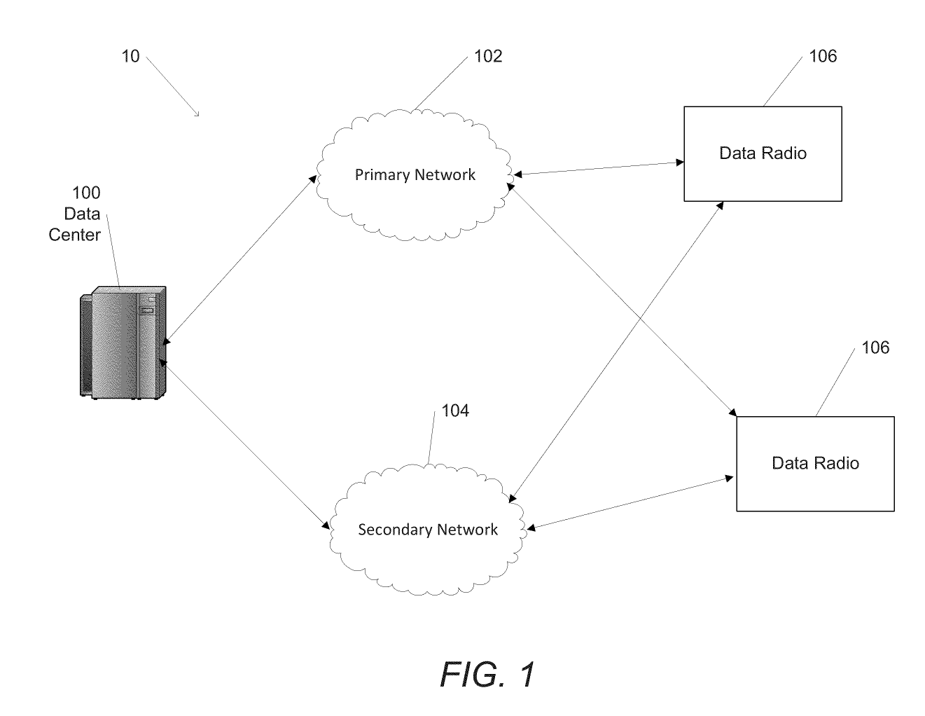

Remotely managed data radios often communicate with data centers to allow for remote monitoring and control of remote devices. A remotely managed data radio network in accordance with an embodiment of the invention is illustrated in FIG. 1. The network 10 includes a data center 100 and one or more remotely managed data radios 106. In a number of embodiments of the invention, some of the remotely managed data radios 106 may be in fixed locations. In several embodiments, some of the data radios 106 may be mobile. The data center 100 is connected to the remotely managed data radios 106 via a plurality of networks. In a number of embodiments, a remotely managed data radio 106 includes a plurality of radio modules for communicating on a plurality of networks. In a number of embodiments of the invention, the plurality of networks includes a primary network 102. In many embodiments, the primary network 102 is a positive train control network. In several embodiments, the plurality of networks includes a secondary network 104. In many embodiments of the invention, the secondary network is a public cellular network.

The data center 100 exchanges mission-critical data with the remotely managed data radios 106 utilizing the primary network 102. The data center 100 exchanges non-mission critical data with the remotely managed data radios 106 utilizing the secondary network 104. In many embodiments of the invention, the non-mission critical data includes data related to the management of the remotely managed data radio, including the remote management of firmware updates for remotely managed data radios. In a number of embodiments, the non-mission critical data includes active and standby firmware and configuration versions. In several embodiments, non-mission critical data includes manufacturing information. In many embodiments of the invention, non-mission critical data includes the update history of the data radio. In a number of embodiments, the non-mission critical data includes performance information gathered by the remotely managed data radios 106.

Although a specific architecture of a remotely managed data radio network is shown in FIG. 1, other implementations appropriate to a specific application can be utilized in accordance with embodiments of the invention including implementations that involve the transmission of data via wired and/or wireless networks that are not part of a positive train control network and/or a cellular network. Data radios in accordance with embodiments of the invention and methods of operation of the data radios are discussed further below.

### Data Radio Module

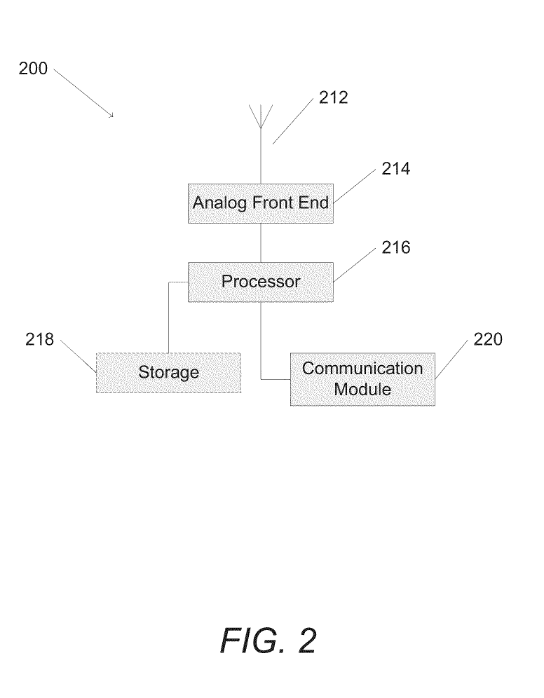

Remotely managed data radios in accordance with a number of embodiments of the invention contain one or more data radio modules. A data radio module in accordance with an embodiment of the invention is illustrated in FIG. 2. A data radio module 200 contains an antenna 210. In many embodiments of the invention, the antenna is tuned to transmit and receive cellular radio signals. In several embodiments, the antenna is tuned to transmit and receive signals from a positive train control network. In a number of embodiments, the antenna is tuned to transmit and receive multiple radio signals. The antenna is connected to an analog front end 214. The data radio module further contains a processor 216. In many embodiments, the analog front end is implemented utilizing the processor 216. In several embodiments, the radio module 200 contains storage 218. In a number of embodiments, the processor 216 is configured to receive and store data utilizing the storage 218. A radio module additionally comprises a communication module 220. In many embodiments of the invention, the communication module is utilized to enable communication between data radio modules. In several embodiments of the invention, the communication module is utilized to allow management of the data radio module. In many embodiments, the data radio module supports a low-power operating mode.

a) In a number of embodiments, a remotely managed data radio includes a primary data radio module and a secondary data radio module. In many embodiments of the invention, the primary data radio module is a positive train control radio. The primary data radio module is configured to communicate on a primary network. In a number of embodiments, the primary network is a positive train control network. The secondary data radio module is configured to communicate on a secondary network. In several embodiments, the secondary network is a public cellular network. In many embodiments of the invention, the secondary data radio module is a Vanguard SC Cellular Router by CalAmp, Inc. of Oxnard, Calif.

When the primary network and/or the primary data radio fails, mission critical data can be communicated over the secondary network by the secondary data radio. In several embodiments, the failure of the primary network and/or primary data radio is detected and mission-critical communications are switched to the secondary network and secondary data radio. In this way, the secondary network and the secondary data radio can provide redundancy with respect to mission-critical communications until the primary network and/or primary data radio are restored.

Although a specific architecture of a data radio module is shown in FIG. 2, other implementations appropriate to a specific application can be utilized in accordance with embodiments of the invention, including implementations that involve remotely managed data radios comprising three or more data radio modules and data radio modules capable of communicating on multiple networks. Methods of operation of multiple network data radios in accordance with embodiments of the invention are discussed further below.

### Multiple Network Data Radio Operation

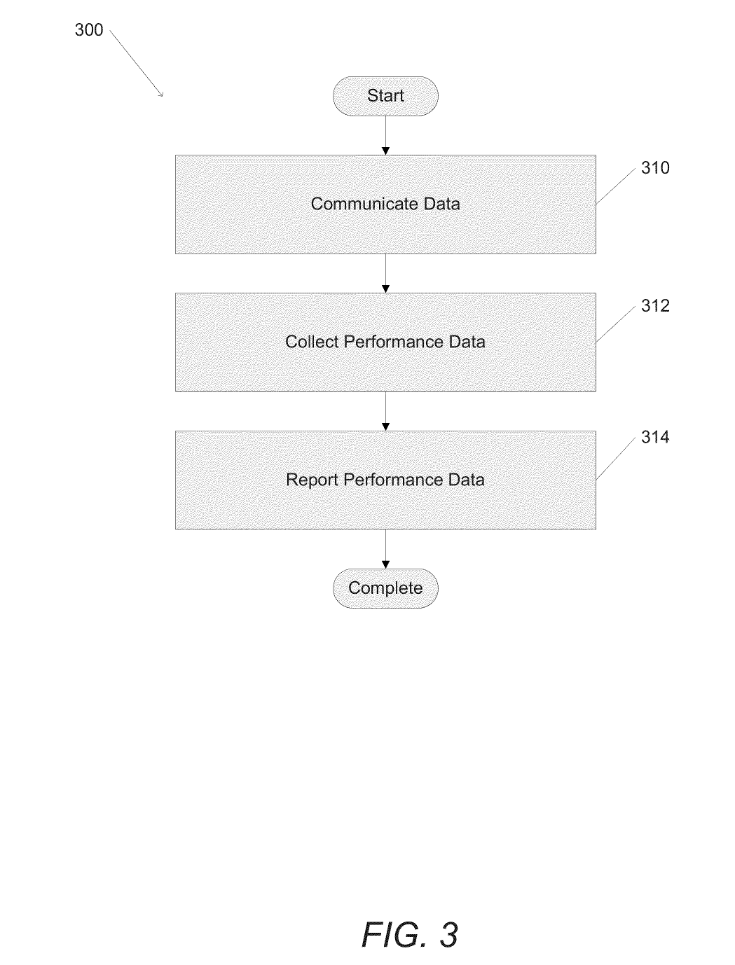

In operation, remotely managed data radios are configured to transmit and receive information. A flow chart illustrating a method of operating a remotely managed data radio in accordance with an embodiment of the invention is illustrated in FIG. 3. Operating 300 a remotely managed data radio involves communicating (310) mission critical data utilizing a primary network. The mission critical data may be transmitted or received by the remotely managed data radio. In several embodiments, non-mission critical data is communicated (310) to the remotely managed data radio utilizing a secondary network. In a number of embodiments of the invention, the non-mission critical data communicated (310) on the secondary network includes instructions to the remotely managed data radio. These instructions can instruct the radio to load a particular firmware version or to remove unused or corrupted firmware images and configuration scripts. In many embodiments of the invention, data communicated (310) on the secondary network includes remote debugging information.

The remotely managed data radio collects (312) data. The collected data may be mission critical or non-mission critical data. In a number of embodiments, the collected data is related to the network performance. In many embodiments, the collected data is related to the physical location of the remotely managed data radio. In several embodiments of the invention, the collected data is related to the coverage area of the remotely managed data radio. In a number of embodiments, the collected data is related to the location information of the remotely managed data radio. The remotely managed data radio reports (314) non-mission critical data utilizing the secondary network. In many embodiments of the invention, the communications 310 are encrypted utilizing any of a variety of encryption techniques.

Although a specific method for operating a remotely managed data radio in accordance with an embodiment of the invention is shown in FIG. 3, other methods appropriate to a specific application can be utilized in accordance with embodiments of the invention. Methods for reporting performance information and updating remotely managed data radios in accordance with embodiments of the invention are discussed further below.

### Reporting Performance Information

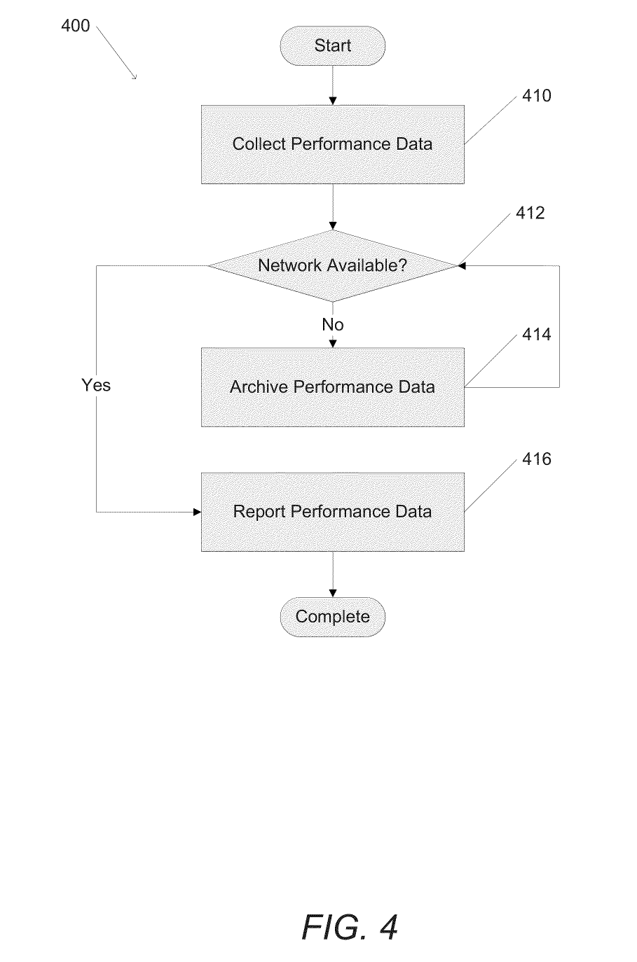

Remotely managed data radios in accordance with embodiments of the invention routinely report data related to the performance of the remotely managed data radio. This performance data can be used to analyze and improve performance. A method for reporting performance data in accordance with an embodiment of the invention is illustrated in FIG. 4. A remotely managed data radio collects (410) performance data. In several embodiments, the remotely managed data radio may be configured to report performance data utilizing a wireless network such as a public cellular network. However, networks, wireless network in particular, are not always available. This is especially true when utilizing mobile remotely managed data radios. When the network is unavailable, data cannot be reported. The remotely managed data radio determines the availability (412) of the network. If the network is unavailable, the remotely managed data radio archives (414) the performance data. When the network becomes available, the remotely managed data radio reports (416) the performance data.

In many embodiments of the invention, the collection (410) of performance data involves a secondary data radio module polling a primary data radio module for data. In a number of embodiments, the reporting of performance data is in response to a request for performance data. In several embodiments, the reporting of performance data is performed according to a schedule. In many embodiments, the reporting of performance data occurs when there is data to report or when a request for a report is received by either the primary or the secondary data radio module.

Although a specific method for reporting performance data utilizing a remotely managed data radio in accordance with an embodiment of the invention is shown in FIG. 4, other methods appropriate to a specific application can be utilized in accordance with embodiments of the invention. Methods for updating data radios in accordance with embodiments of the invention are discussed further below.

### Data Radio Update

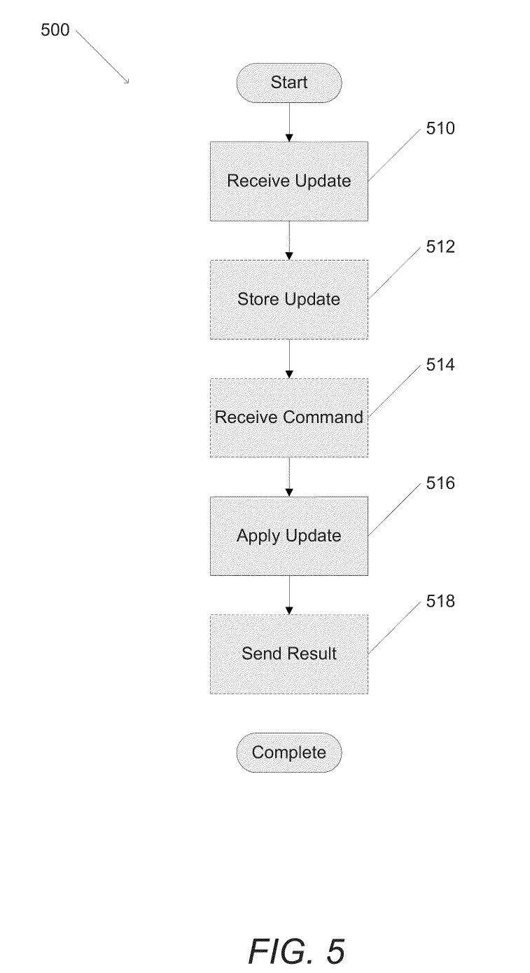

From time to time, remotely managed data radios may need firmware or configuration updates. For remote performance systems installed in distant or difficult to reach locations, it may be prohibitively time consuming or dangerous to send a technician out in the field to manage a remotely managed data radio. A method for updating a remotely managed data radio in accordance with an embodiment of the invention is illustrated in FIG. 5. The update process 500 involves receiving (510) an update. In many embodiments, the update is received over a secondary network. In a number of embodiments, the update is a firmware update or an updated configuration. In many embodiments of the invention, the update is stored (512) for later processing. In several embodiments, the remotely managed data radio receives an update command (514). The update command (514) may be synchronized across a plurality of data radios. The remotely managed data radio applies (516) the update. In a number of embodiments of the invention, the data radio reports (518) the result of the update.

A remotely managed data radio may contain a primary data radio module and a secondary data radio module connected to a primary network and a secondary network respectively. In several embodiments of the invention, the update may be received (510) and stored (512) by the secondary data radio module utilizing the secondary network. The update command (514) is received by the secondary data radio module utilizing the secondary network, which instructs the secondary data ratio to update (516) the primary data radio module. The secondary radio module then reports (518) the results of the update of the primary data radio module. In a number of embodiments of the invention, the report (518) is communicated by one or more methods, including, but not limited to, a web service call, email, SMS, or RPC.

Although a specific method for updating a remotely managed data radio in accordance with an embodiment of the invention is illustrated in FIG. 5, other methods appropriate to a specific application can be utilized in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive.

What is claimed:

1. A remotely managed data radio comprising:
first and second data radio modules;
wherein the first data radio module configured to communicate on a first network;
wherein the first network is a wide area network comprising an amount of bandwidth and a latency for a given frequency channel;
wherein the second data radio module configured to communicate on a second network; and
wherein the remotely managed data radio is configured to:
communicate mission-critical data utilizing the first data radio module;
measure the performance of the first network using the first data radio module;
generate non-mission-critical data using the second data radio module, where the non-mission-critical data comprises the measured performance data; and
communicate the non-mission-critical data utilizing the second data radio module, thereby preserving the bandwidth and latency of the primary network for communicating mission-critical data.

2. The remotely managed data radio of claim 1, wherein each data radio module comprises an antenna module, an analog front end module, a processor, storage, and a communication module.

3. The remotely managed data radio of claim 2, wherein the first and second data radio modules are implemented using a data radio module configured to communicate on multiple networks.

4. The remotely managed data radio of claim 2, wherein the second data radio module is configured to communicate with the first data radio module utilizing the communication module.

5. The remotely managed data radio of claim 4, wherein the second radio module is configured to manage the first data radio module.

6. The remotely managed data radio of claim 1, wherein the remotely managed data radio is further configured to:
receive an update utilizing the second radio module via the second network;
receive at least one instruction to apply the update via the second network using the second radio module;
apply the update to the first data radio module in response to the received at least one instruction.

7. The remotely managed data radio of claim 6, wherein the remotely managed data radio is further configured to report the result of the update to the first radio module using the second radio module via the second network.

8. The remotely managed data radio of claim 7, wherein the remotely managed data radio is further configured to:
determine if the second network is available using the second radio module;
buffer the result of the update when the second network is unavailable; and
report the result of the update when the second network is available using the second radio module.

9. The remotely managed data radio of claim 1, wherein the remotely managed data radio is further configured to:
determine the availability of the first network using the first radio module;
when the first network is unavailable, communicate mission-critical data via the second network using the second radio module; and
when the first network is available, communicate mission-critical data via the first network using the first radio module.

10. The remotely managed data radio of claim 1, wherein:
the first network is a positive train control network; and
the mission-critical data comprises positive train control data.

11. The remotely managed data radio of claim 1, wherein the second network is a public cellular network.

12. The remotely managed data radio of claim 1, wherein the non-mission-critical data further comprised data selected from the group consisting of management data, update data, firmware version data, configuration version data, and update history data.

13. The remotely managed data radio of claim 12, wherein the non-mission critical data is synchronized across a plurality of remotely managed data radios.

14. The remotely managed data radio of claim 1, wherein:
the remotely managed data radio is configured to communicate with a data center configured to communicate data on both the first network and the second network;
the data center and the remotely managed data radio are configured to communicate mission critical data utilizing the first network; and
the data center and the remotely managed data radio are configured to communicate non-mission critical data utilizing the second network.

15. A method for operating a remotely managed data radio, comprising:
communicating mission critical data on a primary network using a remotely managed data radio, where the remotely managed data radio comprises:
first and second data radio modules;
wherein the first data radio module configured to communicate on a first network; and
wherein the second data radio module configured to communicate on a second network;
communicating non-mission critical data on a secondary network independent of the primary network; and
measuring performance of the primary network using the remotely managed data radio.

16. The method of claim 15, wherein:
the first network is a wide area network comprising an amount of bandwidth and a latency for a given frequency channel; and
communicating non-mission critical data on the secondary network independently of the primary network preserves the bandwidth and latency of the primary network for communicating mission critical data using the remotely managed data radio

17. The method of claim 15, further comprising:
receiving an update utilizing a secondary radio module in the remotely managed data radio via the secondary network;
receiving an instruction via the secondary network using the secondary radio module to apply the update;
applying the update to a primary data radio module in the remotely managed data radio; and
reporting the result of the update to the primary radio module using the secondary radio module via the secondary network.

18. The method of claim 17, further comprising:
determining if the secondary network is available using the secondary radio module;
buffering the result of the update if the secondary network is unavailable; and
reporting the result of the update when the secondary network is available using the secondary radio module.

19. The method of claim 18, wherein the result of the update comprises the measured performance of the first network.

20. The method of claim 15, further comprising:
communicating mission critical data to a data center via the primary network using the remotely managed data radio, where the data center is configured to communicate data on both the first network and the second network; and
communicating non-mission critical data to the data center via the secondary network using the remotely managed data radio.
